(19) United States
(12) Patent Application Publication
(10) Pub. No.: US 2026/0133694 A1
(43) Pub. Date: May 14, 2026

(54) MEMORY SYSTEM WITH A DYNAMIC CAPACITY

(71) Applicant: Micron Technology, Inc., Boise, ID (US)

(72) Inventor: Rishabh DUBEY, Agrate Brianza (IT)

(21) Appl. No.: 19/332,693

(22) Filed: Sep. 18, 2025

Related U.S. Application Data
(60) Provisional application No. 63/719,006, filed on Nov. 11, 2024.

(51) Int. Cl. G06F 3/06

(52) U.S. Cl. CPC G06F 3/0608; G06F 3/064; G06F 3/0673

(57) ABSTRACT

Implementations herein relate to a memory system with a dynamic capacity. In some implementations, the memory system may include a set of memory arrays that corresponds to a first address space and that includes a plurality of disjoint subsets of memory arrays. Additionally, the first address space may be divided into a plurality of capacity blocks that are each associated with a respective one of the plurality of disjoint subsets. The memory system may additionally include error detection circuitry configured to detect an error in a memory array within a first disjoint subset and a controller configured to remap a portion of the plurality of capacity blocks to a second address space, where the second address space does not include a first capacity block based on the first capacity block being associated with the first disjoint subset including the error.

### CROSS-REFERENCE TO RELATED APPLICATION

This patent application claims priority to U.S. Provisional Patent Application No. 63/719,006, filed on Nov. 11, 2024, entitled “MEMORY SYSTEM WITH A DYNAMIC CAPACITY,” and assigned to the assignee hereof. The disclosure of the prior application is considered part of and is incorporated by reference into this patent application.

### TECHNICAL FIELD

The present disclosure generally relates to memory devices, memory device operations, and, for example, to a memory system with a dynamic capacity.

### BACKGROUND

Memory devices are widely used to store information in various electronic devices. A memory device may memory cells that are electronic circuits capable of being programmed to a data state of two or more data states. For example, a memory cell may be programmed to a data state that represents a single binary value, often denoted by a binary “1” or a binary “0,” or more than one binary value. As another example, a memory cell may be programmed to a data state that represents a fractional value (e.g., 0.5, 1.5, or the like). To store information, an electronic device may write to, or program, a set of memory cells. To access the stored information, the electronic device may read, or sense, the stored state from the set of memory cells.

Various types of memory devices exist, including random access memory (RAM), read only memory (ROM), dynamic RAM (DRAM), static RAM (SRAM), synchronous dynamic RAM (SDRAM), ferroelectric RAM (FeRAM), magnetic RAM (MRAM), resistive RAM (RRAM), holographic RAM (HRAM), flash memory (e.g., NAND memory and NOR memory), and others. A memory device may be volatile or non-volatile. Non-volatile memory (e.g., flash memory) can store data for extended periods of time even in the absence of an external power source. Volatile memory (e.g., DRAM) may lose stored data over time unless the volatile memory is refreshed by a power source.

### BRIEF DESCRIPTION OF THE DRAWINGS

FIG. 1 is a diagram illustrating an example system that supports a memory system with a dynamic capacity.

FIG. 2 is a diagram illustrating another example system that supports a memory system with a dynamic capacity.

FIG. 3 is a diagram illustrating a memory system with a dynamic capacity.

FIG. 4A is a diagram of an example that supports a memory system with a dynamic capacity and FIG. 4B is a diagram illustrating a memory system with a dynamic capacity.

FIG. 5A is a diagram of an example that supports a memory system with a dynamic capacity and FIG. 5B is a diagram illustrating a memory system with a dynamic capacity.

FIG. 6 is a diagram of an example that supports a memory system with a dynamic capacity.

FIG. 7 is a flowchart of an example method associated with a memory system with a dynamic capacity.

FIG. 8 is a flowchart of an example method associated with a memory system with a dynamic capacity.

### DETAILED DESCRIPTION

Some memory systems may implement error detection and correction techniques to ensure data integrity and system reliability. For example, a memory system may perform a scanning operation to identify memory arrays (e.g., sets of memory cells, memory segments, memory banks) having one or more errors (e.g., that may not be correctable by error correction code (ECC) circuitry at the memory system). To prevent the identified memory arrays from impacting a reliability of data stored by the memory system, the memory system may offline the channels that are associated with the identified memory arrays. That is, a channel may couple a set of memory arrays (e.g., the memory arrays within one or more memory devices coupled to the channel) to a controller at the memory system. When the memory system identifies one or more memory arrays associated with a channel having the errors, the memory system may disable (e.g., offline) that channel. Based on the channel being disabled, the memory arrays that are associated with that channel may no longer be used by the memory system (e.g., to store data associated with a host system). Accordingly, the memory system may update an address space of the memory system (e.g., that corresponds to the set of addresses that are addressable by the host system) to exclude the addresses corresponding to any of the memory arrays that are associated with the disabled channel.

However, disabling entire channels that are coupled to any memory arrays having errors may lead to a loss in performance at the memory system due to the reduction in channel parallelism and memory bandwidth. Moreover, disabling an entire channel in response to a subset of the memory arrays coupled to that channel having errors may unnecessarily reduce an available memory capacity of the memory system.

In accordance with the techniques described herein, a memory system may divide the address space of the memory system into a set of capacity blocks such that each capacity block corresponds to a portion of the address space (e.g., that is nonoverlapping with other portions of the address space corresponding to other capacity blocks). Here, the portion of the address space that is associated with each capacity block may correspond to a disjoint subset of memory arrays within the memory system. Upon detecting errors within the memory arrays, the controller of the memory system may disable any capacity blocks that are associated with memory arrays having errors. Then, the memory system may remap the remaining capacity blocks, excluding those associated with any defective memory arrays, into a secondary address space that the host system can utilize. This remapping technique allows for removing memory arrays associated with errors (e.g., such as unrecoverable errors) without the need to offline entire memory channels, which may prevent any reduction in channel parallelism. Additionally, each capacity block may be associated with fewer memory arrays than each channel. Accordingly, the memory capacity reduction when disabling a capacity block that is associated with a defective memory array may be less than the memory capacity reduction when disabling a channel that is associated with the defective memory array.

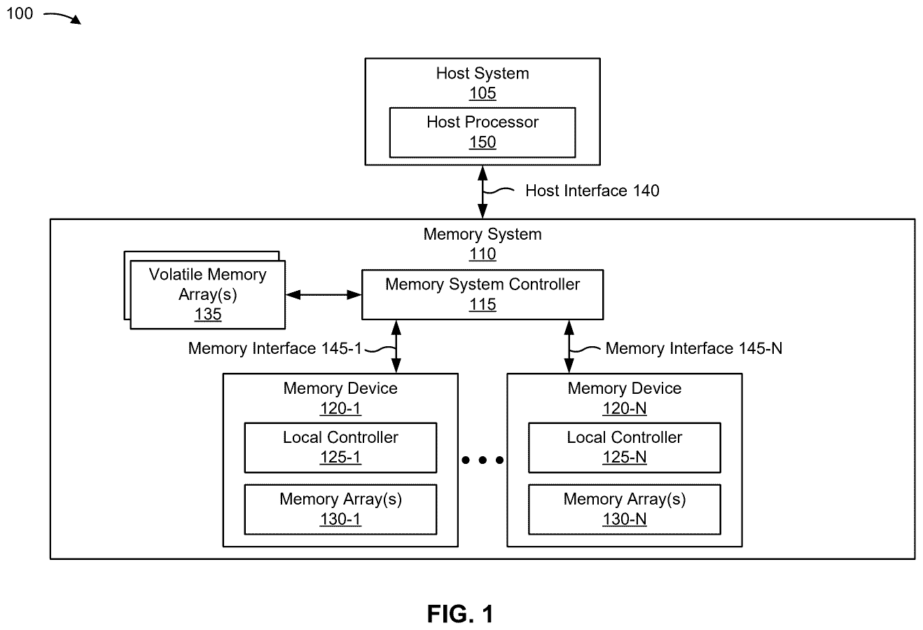

FIG. 1 is a diagram illustrating an example system 100 that supports a memory system with a dynamic capacity. The system 100 may include one or more devices, apparatuses, and/or components for performing operations described herein. For example, the system 100 may include a host system 105 and a memory system 110. The memory system 110 may include a memory system controller 115 and one or more memory devices 120, shown as memory devices 120-1 through 120-N (where N≥1). A memory device may include a local controller 125 and one or more memory arrays 130. The host system 105 may communicate with the memory system 110 (e.g., the memory system controller 115 of the memory system 110) via a host interface 140 (e.g., including host interface circuitry). The memory system controller 115 and the memory devices 120 may communicate via respective memory interfaces 145, shown as memory interfaces 145-1 through 145-N (where N≥1).

The system 100 may be any electronic device configured to store data in memory. For example, the system 100 may be a computer, a mobile phone, a wired or wireless communication device, a network device, a server, a device in a data center, a device in a cloud computing environment, a vehicle (e.g., an automobile or an airplane), and/or an Internet of Things (IoT) device. The host system 105 may include a host processor 150. The host processor 150 may include one or more processors configured to execute instructions and store data in the memory system 110. For example, the host processor 150 may include a CPU, a graphics processing unit (GPU), a field-programmable gate array (FPGA), an application-specific integrated circuit (ASIC), and/or another type of processing component.

The memory system 110 may be any electronic device or apparatus configured to store data in memory. For example, the memory system 110 may be a hard drive, a solid-state drive (SSD), a flash memory system (e.g., a NAND flash memory system or a NOR flash memory system), a universal serial bus (USB) drive, a memory card (e.g., a secure digital (SD) card), a secondary storage device, a non-volatile memory express (NVMe) device, an embedded multimedia card (eMMC) device, a dual in-line memory module (DIMM), a compute express link (CXL) memory module, and/or a random-access memory (RAM) device, such as a dynamic RAM (DRAM) device or a static RAM (SRAM) device.

The memory system controller 115 may be any device configured to control operations of the memory system 110 and/or operations of the memory devices 120. For example, the memory system controller 115 may include control logic, a memory controller, a system controller, an ASIC, an FPGA, a processor, a microcontroller, and/or one or more processing components. In some implementations, the memory system controller 115 may communicate with the host system 105 and may instruct one or more memory devices 120 regarding memory operations to be performed by those one or more memory devices 120 based on one or more instructions from the host system 105. For example, the memory system controller 115 may provide instructions to a local controller 125 regarding memory operations to be performed by the local controller 125 in connection with a corresponding memory device 120.

A memory device 120 may include a local controller 125 and one or more memory arrays 130. In some implementations, a memory device 120 includes a single memory array 130. In some implementations, each memory device 120 of the memory system 110 may be implemented in a separate semiconductor package or on a separate die that includes a respective local controller 125 and a respective memory array 130 of that memory device 120. The memory system 110 may include multiple memory devices 120.

A local controller 125 may be any device configured to control memory operations of a memory device 120 within which the local controller 125 is included (e.g., and not to control memory operations of other memory devices 120). For example, the local controller 125 may include control logic, a memory controller, a system controller, an ASIC, an FPGA, a processor, a microcontroller, a CXL controller connected to DRAM, and/or one or more processing components. In some implementations, the local controller 125 may communicate with the memory system controller 115 and may control operations performed on a memory array 130 coupled to the local controller 125 based on one or more instructions from the memory system controller 115. As an example, the memory system controller 115 may be an SSD controller, and the local controller 125 may be a NAND controller.

A memory array 130 may include an array of memory cells configured to store data. For example, a memory array 130 may include a non-volatile memory array (e.g., a NAND memory array or a NOR memory array) or a volatile memory array (e.g., an SRAM array or a DRAM array). In some implementations, the memory system 110 may include one or more volatile memory arrays 135. A volatile memory array 135 may include an SRAM array and/or a DRAM array, among other examples. The one or more volatile memory arrays 135 may be included in the memory system controller 115, in one or more memory devices 120, and/or in both the memory system controller 115 and one or more memory devices 120. In some implementations, the memory system 110 may include both non-volatile memory capable of maintaining stored data after the memory system 110 is powered off, and volatile memory (e.g., a volatile memory array 135) that requires power to maintain stored data and that loses stored data after the memory system 110 is powered off. For example, a volatile memory array 135 may cache data read from or to be written to non-volatile memory, and/or may cache instructions to be executed by a controller of the memory system 110.

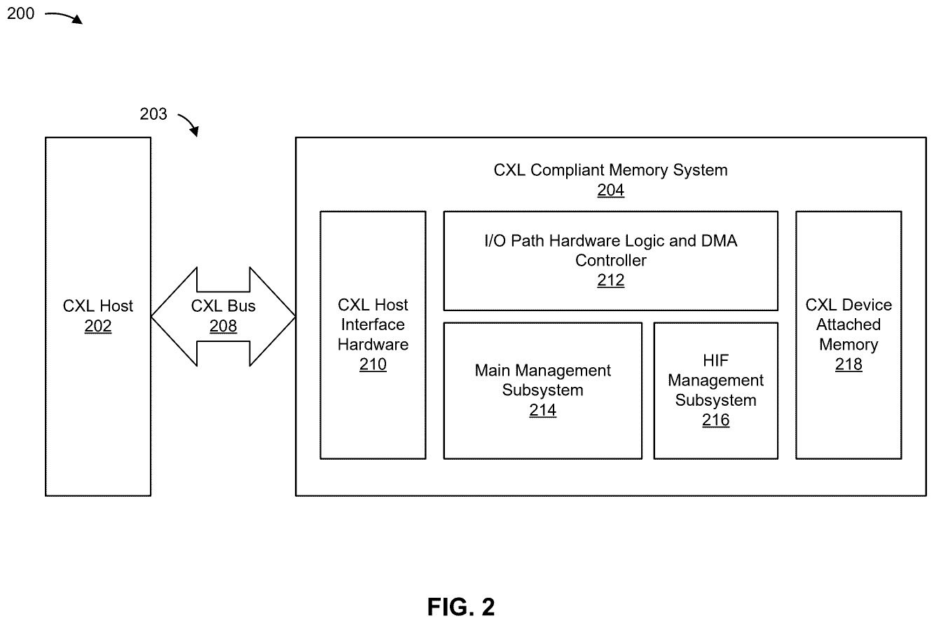

The host interface 140 enables communication between the host system 105 (e.g., the host processor 150) and the memory system 110 (e.g., the memory system controller 115). The host interface 140 may include, for example, a Small Computer System Interface (SCSI), a Serial-Attached SCSI (SAS), a Serial Advanced Technology Attachment (SATA) interface, a Peripheral Component Interconnect Express (PCIe) interface, an NVMe interface, a USB interface, a Universal Flash Storage (UFS) interface, an eMMC interface, a double data rate (DDR) interface, a DIMM interface, and/or a CXL interface (e.g., a PCIe/CXL interface, described in more detail below in connection with FIG. 2).

The memory interface 145 enables communication between the memory system 110 and the memory device 120. The memory interface 145 may include a non-volatile memory interface (e.g., for communicating with non-volatile memory), such as a NAND interface or a NOR interface. Additionally, or alternatively, the memory interface 145 may include a volatile memory interface (e.g., for communicating with volatile memory), such as a DDR interface.

Although the example memory system 110 described above includes a memory system controller 115, in some implementations, the memory system 110 does not include a memory system controller 115. For example, an external controller (e.g., included in the host system 105) and/or one or more local controllers 125 included in one or more corresponding memory devices 120 may perform the operations described herein as being performed by the memory system controller 115. Furthermore, as used herein, a “controller” may refer to the memory system controller 115, a local controller 125, or an external controller. In some implementations, a set of operations described herein as being performed by a controller may be performed by a single controller. For example, the entire set of operations may be performed by a single memory system controller 115, a single local controller 125, or a single external controller. Alternatively, a set of operations described herein as being performed by a controller may be performed by more than one controller. For example, a first subset of the operations may be performed by the memory system controller 115 and a second subset of the operations may be performed by a local controller 125. Furthermore, the term “memory apparatus” may refer to the memory system 110 or a memory device 120, depending on the context.

A controller (e.g., the memory system controller 115, a local controller 125, or an external controller) may control operations performed on memory (e.g., a memory array 130), such as by executing one or more instructions. For example, the memory system 110 and/or a memory device 120 may store one or more instructions in memory as firmware, and the controller may execute those one or more instructions. Additionally, or alternatively, the controller may receive one or more instructions from the host system 105 and/or from the memory system controller 115, and may execute those one or more instructions. In some implementations, a non-transitory computer-readable medium (e.g., volatile memory and/or non-volatile memory) may store a set of instructions (e.g., one or more instructions or code) for execution by the controller. The controller may execute the set of instructions to perform one or more operations or methods described herein. In some implementations, execution of the set of instructions, by the controller, causes the controller, the memory system 110, and/or a memory device 120 to perform one or more operations or methods described herein. In some implementations, hardwired circuitry is used instead of or in combination with the one or more instructions to perform one or more operations or methods described herein. Additionally, or alternatively, the controller may be configured to perform one or more operations or methods described herein. An instruction is sometimes called a “command.”

For example, the controller (e.g., the memory system controller 115, a local controller 125, or an external controller) may transmit signals to and/or receive signals from memory (e.g., one or more memory arrays 130) based on the one or more instructions, such as to transfer data to (e.g., write or program), to transfer data from (e.g., read), to erase, and/or to refresh all or a portion of the memory (e.g., one or more memory cells, pages, sub-blocks, blocks, or planes of the memory). Additionally, or alternatively, the controller may be configured to control access to the memory and/or to provide a translation layer between the host system 105 and the memory (e.g., for mapping logical addresses to physical addresses of a memory array 130). In some implementations, the controller may translate a host interface command (e.g., a command received from the host system 105) into a memory interface command (e.g., a command for performing an operation on a memory array 130).

In some implementations, the memory system 110 of FIG. 1 includes a set of memory arrays 130. The set of memory arrays 130 comprise a plurality of disjoint subsets of memory arrays 130, wherein the set of memory arrays 130 corresponds to a first address space that is addressable by a host system 105, and the first address space is divided into a plurality of capacity blocks that are each associated with a respective one of the plurality of disjoint subsets. The memory system 110 of FIG. 1 further includes error detection circuitry (e.g., within the memory system controller 115, within one or more of the memory devices 120, coupled to the memory system controller 115) coupled to the set of memory arrays 130, the error detection circuitry configured to detect an error in a memory array 130 within a first disjoint subset of the plurality of disjoint subsets. The memory system 110 further includes a controller (e.g., the memory system controller 115) coupled to the set of memory arrays 130 and the error detection circuitry, the controller configured to: remap a portion of the plurality of capacity blocks to a second address space that is addressable by the host system 105, wherein the second address space does not include a first capacity block based at least in part on the first capacity block being associated with the first disjoint subset comprising the error.

In some implementations, one or more systems, devices, apparatuses, components, and/or controllers of FIG. 1 may be configured to perform a plurality of error detection operations on a set of memory arrays 130 corresponding to a first address space that is addressable by a host system 105, wherein the first address space is divided into a plurality of capacity blocks that are each associated with a respective subset of memory arrays; detect, based at least in part on performing the plurality of error detection operations, an error within a first memory array 130 of the set of memory arrays 130, wherein the first memory array 130 is associated with a first capacity block of the plurality of capacity blocks; and remap a portion of the plurality of capacity blocks to a second address space that is addressable by the host system 105, wherein the second address space does not include the first capacity block based at least in part on the first capacity block being associated with the first memory array 130 having the error.

In some implementations, one or more systems, devices, apparatuses, components, and/or controllers of FIG. 1 may be configured to perform a scanning operation of a plurality of memory devices 120 that each comprise a plurality of memory arrays 130, wherein the plurality of memory devices 120 correspond to a first address space that is addressable by a host system 105, wherein the first address space is divided into a plurality of capacity blocks that each comprise a set of memory arrays 130, and wherein each set of memory arrays 130 comprises at least one memory array 130 from each of the plurality of memory devices 120; detect, based at least in part on performing the scanning operation, an error in a first memory array 130 that is within a first capacity block of the plurality of capacity blocks; and remap a portion of the plurality of capacity blocks to a second address space that is addressable by the host system 105, wherein the second address space does not include the first capacity block based at least in part on the first capacity block comprising the first memory array 130 having the error.

The number and arrangement of components shown in FIG. 1 are provided as an example. In practice, there may be additional components, fewer components, different components, or differently arranged components than those shown in FIG. 1. Furthermore, two or more components shown in FIG. 1 may be implemented within a single component, or a single component shown in FIG. 1 may be implemented as multiple, distributed components. Additionally, or alternatively, a set of components (e.g., one or more components) shown in FIG. 1 may perform one or more operations described as being performed by another set of components shown in FIG. 1.

FIG. 2 is a diagram illustrating another example system 200 that supports a memory system with a dynamic capacity. The system 200 may include one or more devices, apparatuses, and/or components for performing operations described herein. In some examples, the system 200 may be associated with a CXL standard and/or protocol (e.g., the system 200 may utilize a CXL protocol to communicate between a host device, sometimes referred to as a CXL compliant host or simply a CXL host, and a memory system, sometimes referred to as a CXL compliant memory system or simply a CXL memory system). In that regard, the system 200 may include a CXL host 202 (which may correspond to the host system 105) and a CXL compliant memory system 204 (which may correspond to the memory system 110). The CXL host 202 and the CXL compliant memory system 204 may communicate via an interface 203 (e.g., host interface 140), which may include a CXL bus 208 (e.g., a PCIe/CXL interface), among other examples.

In some examples, the CXL compliant memory system 204 may be a system that complies with the CXL standard and/or protocol, such as for a purpose of communicating with one or more host devices (e.g., a CXL compliant host, such as CXL host 202). CXL is an open standard that may enable high-speed CPU-to-device and CPU-to-memory interconnects designed to accelerate next-generation performance. The CXL standard may enable memory coherency between the CPU memory space and memory on attached devices, which allows resource sharing for higher performance, reduced software stack complexity, and lower overall system cost. CXL is designed to be an industry open standard for enabling an interface for high-speed communications. CXL technology utilizes the PCIe infrastructure, leveraging PCIe physical and electrical interfaces to provide an advanced protocol in areas such as input/output (I/O) protocol, memory protocol, and coherency interface.

In some examples, the system 200 may include a PCIe/CXL interface (e.g., the CXL bus 208 may be associated with a PCIe/CXL interface), which may be a physical interface configured to connect the CXL compliant memory system 204 to CXL compliant host devices, such as the CXL host 202. In such examples, the PCIe/CXL interface may comply with CXL standard specifications for physical connectivity, ensuring broad compatibility and case of integration into existing systems using the CXL protocol. Additionally, or alternatively, the CXL compliant memory system 204 may be designed to efficiently interface with computing systems (e.g., CXL host 202 and/or a host system 105) by leveraging the CXL protocol. For example, the CXL compliant memory system 204 may be configured to utilize high-speed, low-latency interconnect capabilities of CXL, such as for a purpose of making the CXL compliant memory system 204 suitable for high-performance computing, data center applications, artificial intelligence (AI) applications, and/or similar applications.

In some examples, the CXL compliant memory system 204 may include a CXL memory system controller (e.g., a CXL ASIC, which may correspond to the memory system controller 115 and/or local controller 125), which may be configured to manage data flow between memory arrays (shown as CXL device attached memory 218, which may correspond to the volatile memory arrays 135 and/or the memory arrays 130) and a CXL interface (e.g., the CXL bus 208). In some examples, the CXL memory system controller may be configured to handle one or more CXL protocol layers, such as an I/O layer (e.g., a layer associated with a CXL.io protocol, which may be used for purposes such as device discovery, configuration, initialization, I/O virtualization, direct memory access (DMA) using non-coherent load-store semantics, and/or similar purposes); a cache coherency layer (e.g., a layer associated with a CXL.cache protocol, which may be used for purposes such as caching host memory using a modified, exclusive, shared, invalid (MESI) coherence protocol, or similar purposes); or a memory protocol layer (e.g., a layer associated with a CXL.memory (sometimes referred to as CXL.mem) protocol, which may enable a CXL memory device to expose host-managed device memory (HDM) to permit a host device to manage and access memory similar to a native DDR connected to the host); among other examples.

The CXL compliant memory system 204 may further include and/or be associated with one or more high-bandwidth memory modules (HBMMs) or similar memory arrays (e.g., CXL device attached memory 218). For example, the CXL compliant memory system 204 may include multiple layers of DRAM (e.g., stacked and/or interconnected through advanced through-silicon via (TSV) technology) in order to maximize storage density and/or enhance data transfer speeds between memory layers. Additionally, or alternatively, the CXL compliant memory system 204 (e.g., a CXL ASIC of the CXL compliant memory system 204) may include a power management unit, which may be configured to regulate power consumption associated with the CXL compliant memory system 204 and/or which may be configured to improve energy efficiency for the CXL compliant memory system 204. Additionally, or alternatively, the CXL compliant memory system 204 (e.g., a CXL ASIC of the CXL compliant memory system 204) may include additional components, such as error detection circuitry and/or ECC circuitry, which may detect and/or correct data errors to ensure data integrity and/or improve the overall reliability of the CXL compliant memory system 204. The CXL compliant memory system 204 may be implemented using a combination of hardware and firmware blocks and/or components. In such examples, the firmware may execute on one or more embedded CPUs within the CXL compliant memory system 204.

Additionally, or alternatively, the CXL compliant memory system 204 and/or a CXL memory system controller (e.g., a CXL ASIC) of the CXL compliant memory system 204 may include CXL host interface hardware 210, an I/O path hardware logic and DMA controller 212, a main management subsystem 214, and/or a host interface (HIF) management subsystem 216, among other examples. In some examples, the CXL host interface hardware 210 may be hardware components that enable physical connectivity between the CXL compliant memory system 204 and one or more external devices, such as to the CXL host 202 via the CXL bus 208. In some cases, the CXL host interface hardware 210 may be referred to as host interface circuitry. In some examples, the CXL host interface hardware 210 may include the necessary physical interfaces and protocol logic required to establish and/or maintain communication over the CXL link (e.g., via the CXL bus 208). In some cases, the CXL host interface hardware 210 may ensure that the CXL host 202 can access and/or control the CXL compliant memory system 204 efficiently.

The I/O path hardware logic and DMA controller 212 may handle data transfers between the CXL compliant memory system 204 and external devices, such as other memory modules and/or peripheral components. In some examples, a DMA controller portion of the I/O path hardware logic and DMA controller 212 may permit efficient data transfer without involving a CXL compliant memory system 204 CPU, directly. Put another way, the DMA controller portion of the I/O path hardware logic and DMA controller 212 may manage data movement between the CXL compliant memory system 204 and other system components, which may enhance overall system performance by offloading data transfer tasks from the CPU.

The main management subsystem 214 may serve as a central control and management unit within the CXL compliant memory system 204. In some examples, the main management subsystem 214 may encompass various functionalities and tasks, such as memory access control, error detection and/or correction, power management, and/or similar system management functionalities and/or tasks. Additionally, or alternatively, the main management subsystem 214 may ensure proper functioning and/or reliability of the CXL compliant memory system 204 and/or may optimize the performance of the CXL compliant memory system 204 under various operating conditions.

The HIF management subsystem 216 may be responsible for managing and/or controlling the CXL host interface hardware 210, among other tasks. In some examples, the HIF management subsystem 216 may handle tasks related to link initialization configuration negotiation with the CXL host 202, error handling, and/or other protocol-specific functionalities. Additionally, or alternatively, the HIF management subsystem 216 may ensure smooth communication between the CXL compliant memory system 204 and/or the CXL host 202, such as by maintaining compatibility and/or reliability of the CXL link, among other examples.

In some examples, the CXL compliant memory system 204 may be categorized as a CXL type 1 device, a CXL type 2 device, or a CXL type 3 device. A CXL type 1 device may be a device that implements a coherent cache using the CXL.cache protocol. A CXL type 2 device may be a device that implements both a coherent cache using the CXL.cache protocol and a host-managed device memory using the CXL.mem protocol. For example, a CXL type 2 device may be a hardware accelerator device. A CXL type 3 device may be a device that implements a host-managed device memory using the CXL.mem protocol. For example, a CXL type 3 device may be a memory expander device.

The number and arrangement of components shown in FIG. 2 are provided as an example. In practice, there may be additional components, fewer components, different components, or differently arranged components than those shown in FIG. 2. Furthermore, two or more components shown in FIG. 2 may be implemented within a single component, or a single component shown in FIG. 2 may be implemented as multiple, distributed components. Additionally, or alternatively, a set of components (e.g., one or more components) shown in FIG. 2 may perform one or more operations described as being performed by another set of components shown in FIG. 2.

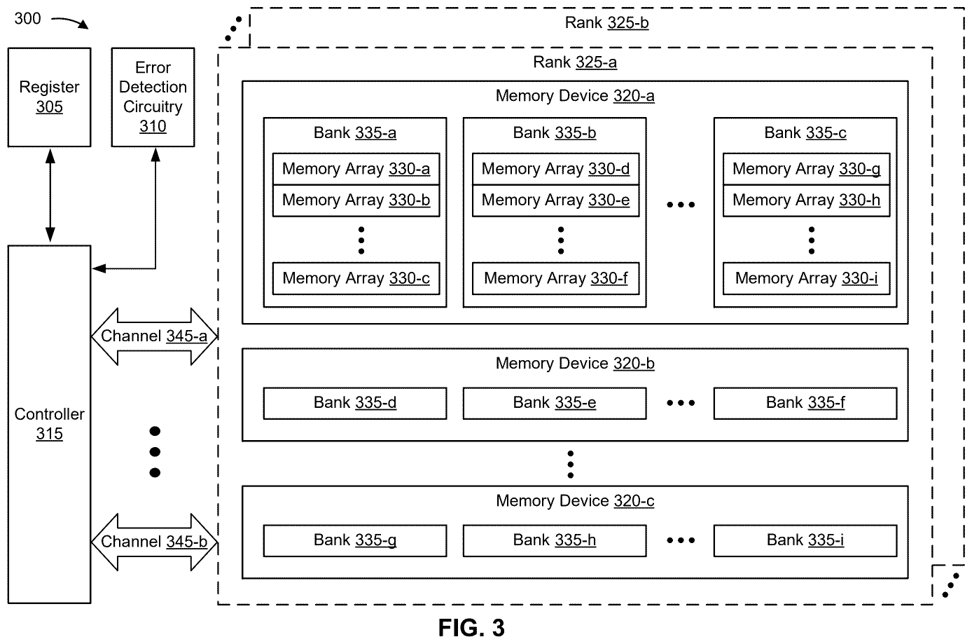

FIG. 3 is a diagram illustrating a memory system 300 with a dynamic capacity. In some cases, the memory system 300 include aspects of systems, devices, or components described with reference to FIGS. 1 and 2. For example, the memory system 300 may include aspects of the memory system 110 or the CXL compliant memory system 204; the controller 315 may include aspects of the memory system controller 115, the local controller 125, or the CXL memory system controller described with reference to FIG. 2; the memory devices 320 may include aspects of the memory devices 120 and the CXL device attached memory 218; the memory arrays 330 may include aspects of the memory arrays 130; and the channels 345 may include aspects of the memory interfaces 145. The operations described in connection with FIG. 3 may be performed by the memory system 110 and/or one or more components of the memory system 110, such as the memory system controller 115, one or more memory devices 120, and/or one or more local controllers 125.

The memory system 300 may include a set of memory devices 320. The memory devices 320 may include volatile memory (e.g., DRAM such as low-power double data rate 5 (LPDDR5) memory) or nonvolatile memory (e.g., SRAM). While the memory system 300 is illustrated as including three memory devices 320, the memory system 300 may include additional memory devices 320 that are not illustrated. For example, the memory system 300 may include 24 or 36 memory devices 320. Each of the memory devices 320 may include one or more banks 335 (which may also be referred to as memory banks 335). For example, the memory device 320-a may include the bank 335-a, 335-b, and 335-c; the memory device 320-b may include the bank 335-d, 335-e, and 335-f; and the memory device 320-c may include bank 335-g, bank 335-h, and bank 335-i. While the memory devices 320 are illustrated as including three banks 335, the memory devices 320 may include more or fewer banks 335. For example, each of the memory devices 320 may include two, four, sixteen, or 32 banks 335.

The banks 335 may include groups of memory arrays 330 and may facilitate concurrent access of more than one memory array 330 in a single bank 335. For example, the bank 335-a may include the memory arrays 330-a, 330-b, and 330-c; the bank 335-b may include the memory arrays 330-d, 330-c, and 330-f; and the bank 335-c may include the memory arrays 330-g, 330-h, and 330-i. FIG. 3 illustrates each of the memory banks 335 as including three memory arrays 330, but each of the banks 335 may include more or fewer memory arrays 330. For example, each of the banks 335 may include eight, sixteen, or 32 memory arrays 330.

The memory system 300 may include more than one rank 325 of memory. Each rank 325 may correspond to a layer of memory cells or a memory die. In the example of the memory system 300, the memory devices 320 may be arranged in a two-rank configuration (e.g., each memory device 320 may include memory arrays 330 arranged on a first rank 325-a or a second rank 325-b). In some other examples, the memory devices 320 may be arranged according to a different rank configuration (e.g., a rank 4 configuration, a rank 8 configuration).

The memory devices 320 (and the corresponding memory arrays 330 and banks 335) may be coupled to the controller 315 via a channel 345. Each channel 345 may couple one or more memory devices 320 (including each of the ranks 325 of that memory device 320) with the controller 315. For example, each channel 345 may couple one memory device 320 with the controller 315. In another example, each channel 345 may couple two memory devices 320 with the controller 315. In this example, the channel 345-a may couple the memory devices 320-a and 320-b with the controller 315. Additionally, the channel 345-b may couple the memory device 320-c and another memory device 320 (e.g., not illustrated in the memory system 300) with the controller 315. In other examples, each channel 345 may couple some other quantity of memory devices 320 with the controller 315 (e.g., three memory devices 320, four memory devices 320, more than four memory devices 320). The memory system 300 may include more than the two channels 345 illustrated in FIG. 3. For example, the memory system 300 may include four, eight, sixteen, eighteen, or some other quantity of channels 345 that couple one or more memory devices 320 to the controller 315.

In some cases, the controller 315 may execute access operations (e.g., read operations, write operations) on memory devices 320 that are coupled to different channels 345 concurrently. For example, the controller 315 may communicate data with the memory device 320-a (e.g., as part of a first access operation) via the channel 345-a and data with the memory device 320-c (e.g., as part of a second access operation) via the channel 345-b concurrently. In some cases, the memory system 300 performing one or more access operations concurrently may decrease a latency associated with access operations executed at the memory system 300 (e.g., as compared to a memory system 300 that does not perform access operations concurrently, or a memory system 300 that performs fewer access operations concurrently). Additionally, memory systems 300 that include more channels 345 coupling memory devices 320 to the controller 315 may have decreased latency as compared to memory systems that include fewer channels 345.

The memory system 300 may include error detection circuitry 310 to detect one or more errors in data stored by the memory devices 320. The error detection circuitry 310 may be included in the controller 315. Additionally, or alternatively, the error detection circuitry 310 may include circuitry distinct from the controller 315 and may be coupled to the controller 315.

The memory system 300 may perform a scanning operation to identify memory arrays 330 having one or more errors (e.g., that may not be correctable by ECC circuitry at the memory system 300). In some cases, the memory system 300 may perform the scanning operation as part of an initialization procedure for the memory system 300. For example, the memory system 300 may initiate the scanning operation internally (e.g., during a startup procedure, at a booting time of the memory system 300, or prior to being coupled to a host system). Here, the controller 315 may perform the scanning operation on each of the memory devices 320 within the memory system 300. In some other examples, the memory system 300 may receive (e.g., from a host system via a host interface 140 or a CXL bus 208) a command to initiate the scanning operation. Here, the command may indicate one or more of the memory devices 320 within the memory system 300 on which to perform the scanning operation. In some other cases, the command may indicate for the controller 315 to perform a scanning operation on each of the memory devices 320 within the memory system 300.

To perform the scanning operation at a memory device 320, the controller 315 may initiate the scanning operation by setting a register (e.g., a register 305) at the memory system 300 to a value indicating that data at the memory system 300 is not valid. For example, the controller 315 may set a memory information register to store a first value (e.g., a ‘0’) that is indicative of the memory system 300 being unable to operate normally (e.g., unable to execute access operations in response to commands from the host system). Then, the controller 315 may perform a set of write operations to write data (e.g., pattern data that is preconfigured or predefined, or otherwise known by the controller 315) to each of the memory arrays 330 within the memory device 320. After performing the set of write operations, the controller 315 may perform a set of read operations to read the data stored in each of the memory arrays 330 within the memory device 320. The error detection circuitry 310 may detect one or more errors in instances where the data read from the memory arrays 330 in the memory device 320 is different from the data written to the memory arrays 330. In some cases, the controller 315 (or, in other cases, the error detection circuitry 310) may determine that the detected errors are unrecoverable in cases where the errors are not correctable by any ECC circuitry at the memory system 300. After completing the scanning operation, the controller 315 may set the register (e.g., the register 305) to a value indicating that the data at the memory system 300 is valid. For example, the controller 315 may set the memory information register to store a second value (e.g., a ‘1’) that is indicative of the memory system 300 being able to operate normally and execute access operations in response to commands received from the host system.

When the controller 315 performs a scanning operation on the set of memory devices 320 in the memory system 300, the error detection circuitry 310 may identify one or more memory arrays 330 associated with unrecoverable errors (e.g., one or more memory arrays 330 that cause data stored within the one or more memory arrays 330 to include unrecoverable errors). In some cases, many uncorrectable errors may be from a specific bank 335 or segment of a bank 335 (e.g., from one or more memory arrays 330 within a single bank 335). Here, the controller 315 may determine to remove this bank 335 from the address space of the memory system 300, to prevent the identified memory arrays 330 from impacting a reliability of data stored by the memory system 300. To remove the bank 335 from the address space, the controller 315 may offline (e.g., disable) the channels 345 that are associated with the identified memory arrays 330. After a channel 345 is disabled, the memory arrays 330 that are associated with that channel 345 may no longer be used by the memory system 300 (e.g., to store data associated with a host system). For example, in cases where the error detection circuitry 310 identifies that the memory array 330-b is associated with one or more unrecoverable errors, the controller 315 may disable the channel 345-a. Here, the memory system 300 may no longer use any of the memory arrays 330 associated with the channel 345-a to store data (e.g., the memory arrays 330 within the memory devices 320-a and 320-b).

Based on disabling one or more channels 345, the controller 315 may update an address space of the memory system 300 (e.g., that corresponds to the set of addresses that are addressable by the host system) to exclude the addresses corresponding to any of the memory arrays 330 that are associated with the disabled channel(s) 345. In the example where the controller 315 disables the channel 345-a, the controller 315 may update the address space of the memory system 300 to exclude the address corresponding to any of the memory arrays 330 within the memory devices 320-a or 320-b (e.g., including all of the memory arrays within the banks 335-a, 335-b, 335-c, 335-d, 335-c, and 335-f). To indicate the updated address space, the controller 315 may update the register 305 to store a value indicative of the updated address space size. For example, the controller 315 may update a field in the register 305 (e.g., a Memory Size field) to be indicative of the updated address space size. In some cases, the register 305 may be a CXL compliant register 305 (e.g., a CXL designated vendor specific extended capability (DVSEC) range register).

However, disabling entire channels 345 that are coupled to any memory arrays 330 having errors may lead to a loss in performance at the memory system 300 due to the reduction in channel parallelism and memory bandwidth. Moreover, disabling an entire channel 345 in response to a subset of the memory arrays 330 coupled to that channel 345 having errors may unnecessarily reduce an available memory capacity of the memory system 300.

In accordance with the techniques described herein, the memory system 300 may divide the address space of the memory system 300 into a set of capacity blocks such that each capacity block corresponds to a portion of the address space (e.g., that is nonoverlapping with other portions of the address space corresponding to other capacity blocks). Here, the portion of the address space that is associated with each capacity block may correspond to a disjoint subset of memory arrays 330 within the memory system 300. Upon detecting unrecoverable errors within data stored by the memory arrays 330, the controller 315 may disable any capacity blocks that are associated with memory arrays 330 having errors. Then, the memory system 300 may remap the remaining capacity blocks, excluding those associated with any defective memory arrays, into a secondary address space that the host system can utilize. This remapping technique may enable the memory system 300 to remove memory arrays 330 associated with errors (e.g., such as unrecoverable errors) without the need to offline entire memory channels 345, which may prevent any reduction in channel parallelism. Additionally, each capacity block may be associated with fewer memory arrays 330 than each channel 345. Accordingly, the memory capacity reduction when disabling a capacity block that is associated with a defective memory array 330 may be less than the memory capacity reduction when disabling a channel 345 that is associated with the defective memory array 330.

After disabling the one or more capacity blocks, the controller 315 may indicate the updated address space by updating the register 305 (e.g., a field in the register 305) to store a value indicative of the updated address space size. For example, the controller 315 may update a field in the register 305 (e.g., a Memory Size field) to be indicative of the updated address space size. In some cases, the register 305 may be a CXL compliant register 305 (e.g., a CXL designated vendor specific extended capability (DVSEC) range register).

As indicated above, FIG. 3 is provided as an example. Other examples may differ from what is described with regard to FIG. 3.

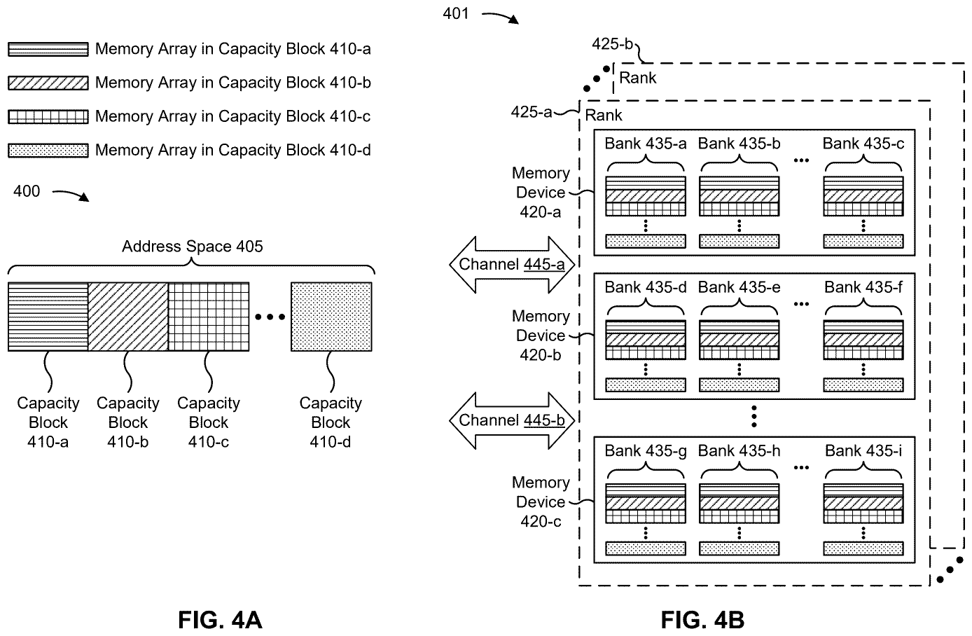

FIG. 4A is a diagram of an example 400 that supports a memory system with a dynamic capacity, and FIG. 4B is a diagram illustrating a memory system 401 with a dynamic capacity. The example 400 illustrates an example address space 405 of the memory system 401, including a division of the address space 405 into a set of capacity blocks 410. In particular, the example 400 and the memory system 401 illustrate an example where the subset of the address space 405 of each capacity block 410 is shared across all of the banks 435 of a single rank 425.

In some cases, the memory system 401 may include aspects of the memory system 300 described with reference to FIG. 3. The operations described in connection with FIG. 4A and FIG. 4B may be performed by the memory system 110 and/or one or more components of the memory system 110, such as the memory system controller 115, one or more memory devices 120, and/or one or more local controllers 125.

In the example 400, the address space 405 of the memory system 401 may correspond to the address space of the memory system 401 that is addressable by a host system. A linear capacity of the memory system 401 (e.g., corresponding to the address space 405) may be divided into a set of capacity blocks 410. Each capacity block 410 may correspond to a subset of the full linear capacity of the memory system 401. For example, each capacity block 410 may correspond to one gigabyte of memory. In some other examples, each capacity block 410 may correspond to a different granularity of the address space 405 (e.g., 256 megabytes, 512 megabytes, two gigabytes, or some other granularity of the address space 405).

Each of the capacity blocks 410 may correspond to one or more memory arrays within the memory system 401. For example, the memory arrays within the memory system 401 may be divided into a plurality of disjoint subsets (e.g., nonoverlapping subsets), and each disjoint subset of memory arrays may be allocated to one of the capacity blocks 410. In some cases, the memory system 401 may store information indicating the allocation of each capacity block 410. For example, the memory system 401 may store the information within a capacity allocation lookup table. An example of the capacity allocation lookup table is provided below in Table 1.

TABLE 1
Capacity Allocation Lookup Table

| Device | Device | Device | | Device | |
|---|---|---|---|---|---|
| 0 | 1 | 2 | . . . | 15 | |
| | | | . . . | | Capacity Block 410-a ID |
| | | | . . . | | Capacity Block 410-a ID |
| | | | . . . | | Capacity Block 410-a ID |
| | | | . . . | | . . . |
| | | | . . . | | Capacity Block 410-a ID |

The capacity allocation lookup table may indicate, for each capacity block 410, one or more logical devices (e.g., device 0, device 1, device 2, device 15) that include the capacity block 410 allocation. In some cases, the capacity allocation lookup table may be stored within the memory system 401, within nonvolatile memory (e.g., SRAM) in a bitmap. The memory system 401 may rely on the capacity allocation lookup table to perform address translation. For example, the memory system 401 may receive commands (e.g., from a host device) indicating an address within the address space 405 for an access operation. The memory system 401 (or a controller at the memory system 401, an application-specific integrated circuit at the memory system 401) may identify which capacity block 410 the address is associated with, and may then read the capacity allocation lookup table (e.g., may read the bitmap comprising the capacity allocation lookup table) to identify a logical device that includes memory arrays storing the information associated with that address. In some cases, firmware of the memory system 401 may update and maintain the capacity allocation lookup table.

In example 400, each of the capacity blocks 410 may be shared across the banks 435 within a single rank 425. That is, each capacity block 410 may include memory arrays from within each bank 435 on a rank 425. For example, the capacity block 410-a may include memory arrays from each of the banks 435 on the rank 425-a. In particular, the capacity block 410-a may include a memory array from each of the banks 435 within the memory device 420-a (e.g., the banks 435-a, 435-b, and 435-c), each of the banks 435 within the memory device 420-b (e.g., the banks 435-d, 435-e, and 435-f), and each of the banks 435 within the memory device 420-c (e.g., the banks 435-g, 435-h, and 435-i). The capacity blocks 410-b, 410-c, and 410-d may similarly include memory arrays from each of the banks 435 of the rank 425-a. While not illustrated, the address space 405 may also include other capacity blocks 410 that include memory arrays from each of the banks 435 within other ranks 425 (e.g., such as the rank 425-b).

The memory system 401 may detect one or more errors within data stored by a memory array (e.g., as part of a scanning operation). In some cases, the memory system 401 may determine that the memory array is faulty based on detecting the one or more errors. For example, in cases where there are one or more unrecoverable errors within the data stored by the memory array, the memory system 401 may determine that the memory array is faulty. Then, the memory system 401 (e.g., a controller at the memory system 401) may identify a capacity block 410 that is associated with the faulty memory array. For example, the memory system 401 may read data stored in a capacity lookup table (e.g., as described with reference to Table 1) to identify one of the capacity blocks 410 that is associated with the memory array. In some cases, the capacity lookup table may identify disjoint subsets of the memory arrays at the memory system 401 that are associated with each of the capacity blocks 410. Then the memory system 401 may identify a capacity block 410 associated with a disjoint subset including the faulty memory array.

In one example, the memory system 401 may detect one or more errors in data stored by a memory array in the bank 435-d and may determine that the memory array is faulty. The memory system 401 may then identify that the memory array is associated with the capacity block 410-b (e.g., based on the capacity lookup table). In some cases, the memory system 401 may detect errors within multiple memory arrays and may subsequently determine that the multiple memory arrays are faulty. Here, the memory system 401 may identify one or more capacity blocks 410 that are associated with the multiple faulty memory arrays. For example, the memory system 401 may identify that the capacity blocks 410-c and 410-d are associated with one or more faulty memory arrays.

The memory system 401 may remap a portion of the capacity blocks 410 to a second address space (e.g., an address space that is smaller than the address space 405) based on identifying that one or more of the capacity blocks 410 are associated with faulty memory arrays. In particular, the memory system 401 may exclude the one or more capacity blocks 410 that are associated with faulty memory arrays from the second address space. For example, if the memory system 401 identifies that the capacity block 410-a is associated with one or more faulty memory arrays, the memory system 401 may remap the remaining capacity blocks 410-b, 410-c, and 410-d (e.g., any of the capacity blocks 410 within the address space 405 not associated with faulty memory arrays) to the second address space. Thus, the memory system 401 may exclude a portion of the address space 405 corresponding to the memory arrays that are in the capacity block 410-a (e.g., which includes one memory array from each of the banks 435 in rank 425-a).

Based on remapping the portion of the capacity blocks 410 to a second (e.g., smaller) address space, the memory system 401 may prevent future access operations within the faulty memory arrays (e.g., by excluding them from the address space 405). In some cases, removing a capacity block 410 from the address space 405 may result in a smaller decrease in memory capacity of the memory system 401 as compared to disabling a channel 445. That is, each capacity block 410 may be associated with a first quantity of memory arrays that is less than a second quantity of memory arrays coupled to each channel 445. Additionally, removing one or more capacity blocks 410 from the address space 405 maintains the channel parallelism of the memory system 401.

As indicated above, FIGS. 4A and 4B are provided as examples. Other examples may differ from what is described with regard to FIGS. 4A and 4B.

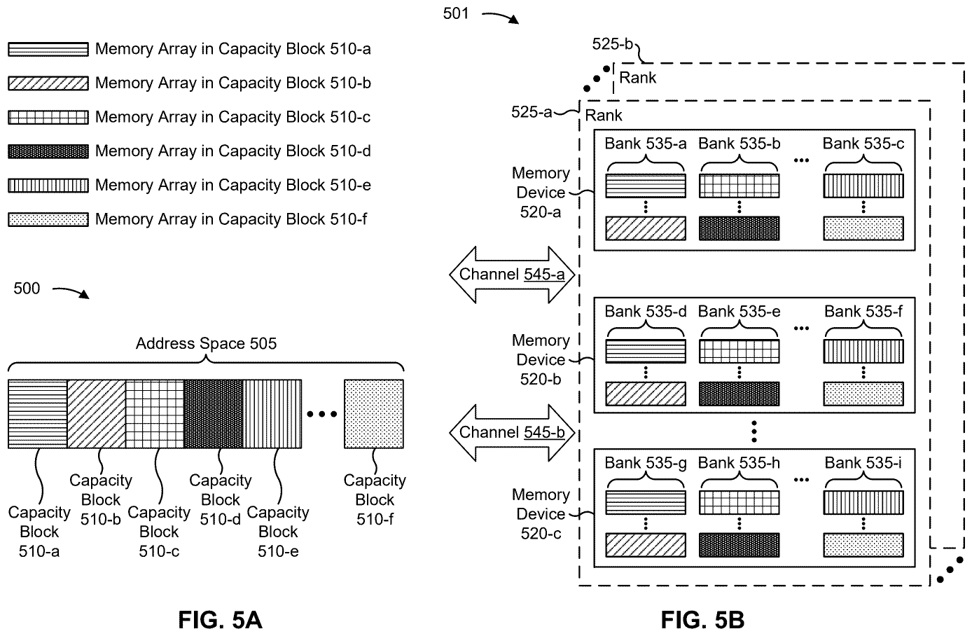

FIG. 5A is a diagram of an example 500 that supports a memory system with a dynamic capacity, and FIG. 5B is a diagram illustrating a memory system 501 with a dynamic capacity. The example 500 illustrates an example address space 505 of the memory system 501, including a division of the address space 505 into a set of capacity blocks 510. The example 500 and the memory system 501 may be similar to the example 400 and the memory system 401, but may differ in that the subset of the address space 505 of each capacity block 510 is not shared across all of the banks 535 of a rank 525. The operations described in connection with FIGS. 5A and 5B may be performed by the memory system 110 and/or one or more components of the memory system 110, such as the memory system controller 115, one or more memory devices 120, and/or one or more local controllers 125.

In the example 500, the address space 505 of the memory system 501 may correspond to the address space of the memory system 501 that is addressable by a host system. A linear capacity of the memory system 501 (e.g., corresponding to the address space 505) may be divided into a set of capacity blocks 510. Each capacity block 510 may correspond to a subset of the full linear capacity of the memory system 501. Each of the capacity blocks 510 may correspond to one or more memory arrays within the memory system 501. For example, the memory arrays within the memory system 501 may be divided into a plurality of disjoint subsets (e.g., nonoverlapping subsets), and each disjoint subset of memory arrays may be allocated to one of the capacity blocks 510. The memory system 501 may rely on a capacity allocation lookup table (e.g., as described with reference to FIGS. 4A-4B and illustrated in Table 1) to determine the allocation of memory arrays to each of the capacity blocks 510.

In this example 500, the capacity blocks 510 may not be shared across the banks 535 within a rank 525. That is, each capacity block 510 may include memory arrays from within a subset of the banks 535 on a rank 525. For example, the capacity block 510-a may include memory arrays from less than all of the banks 535 on the rank 525-a. In particular, the capacity block 510-a may include a memory array from the banks 535-a, 535-d, and 535-g, but may not include memory arrays from the banks 525-b, 535-c, 535-c, 535-f, 535-h, or 535-i. The capacity blocks 510-b, 510-c, and 510-d may similarly include memory arrays from each of a subset of the banks 535 of the rank 525-a. While not illustrated, the address space 505 may also include other capacity blocks 510 that include memory arrays from a subset of the banks 535 within other ranks 525 (e.g., such as the rank 525-b).

The memory system 501 may detect one or more errors within data stored by a memory array (e.g., as part of a scanning operation). In some cases, the memory system 501 may determine that the memory array is faulty based on detecting the one or more errors. Then, the memory system 501 (e.g., a controller at the memory system 501) may identify a capacity block 510 that is associated with the faulty memory array.

The memory system 501 may remap a portion of the capacity blocks 510 to a second address space (e.g., an address space that is smaller than the address space 505) based on identifying that one or more of the capacity blocks 510 are associated with faulty memory arrays. In particular, the memory system 501 may exclude the one or more capacity blocks 510 that are associated with faulty memory arrays from the second address space. For example, if the memory system 501 identifies that the capacity block 510-a is associated with one or more faulty memory arrays, the memory system 501 may remap the remaining capacity blocks 510-b, 510-c, and 510-d (e.g., any of the capacity blocks 510 within the address space 505 not associated with faulty memory arrays) to the second address space. In the example 500 and the memory system 501, when the memory system 501 excludes a capacity block 510 from the second address space, the memory system 501 may exclude one or more memory arrays from a subset of the banks 535 in a rank 525 (e.g., less than all the banks 535 in the rank 525).

Based on remapping the portion of the capacity blocks 510 to a second (e.g., smaller) address space, the memory system 501 may prevent future access operations within the faulty memory arrays (e.g., by excluding them from the address space 505). In some cases, removing a capacity block 510 from the address space 505 may result in a smaller decrease in memory capacity of the memory system 501 as compared to disabling a channel 545. That is, each capacity block 510 may be associated with a first quantity of memory arrays that is less than a second quantity of memory arrays coupled to each channel 545. Additionally, removing one or more capacity blocks 510 from the address space 505 maintains the channel parallelism of the memory system 501.

As indicated above, FIGS. 5A and 5B are provided as examples. Other examples may differ from what is described with regard to FIGS. 5A and 5B.

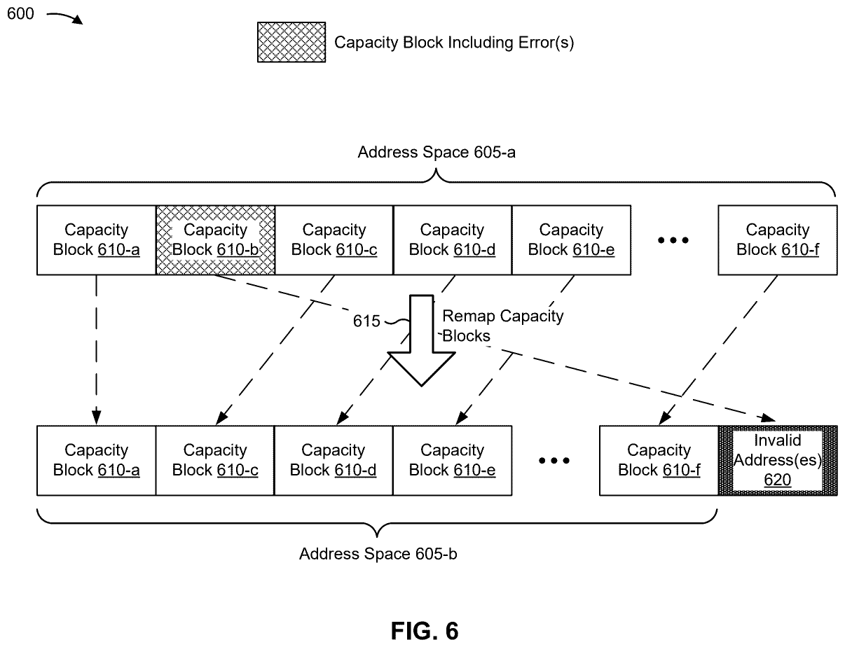

FIG. 6 is a diagram of an example 600 that supports a memory system with a dynamic capacity. The operations described in connection with FIG. 6 may be performed by the memory system 110 and/or one or more components of the memory system 110, such as the memory system controller 115, one or more memory devices 120, and/or one or more local controllers 125. For example, a memory system (e.g., the memory system 110, the CXL compliant memory system 204, the memory system 300, 401, and/or 501) may perform the operations described in connection with the example 600 in response to detecting errors (e.g., uncorrectable errors) in one or more memory arrays within the capacity block 610-b.

The address space 605-a may be an example of the address spaces 405 and 505 described with reference to FIGS. 4 and 5, respectively. As shown by reference number 615, and based on detecting errors in one or more memory arrays within the capacity block 610-b of the address space 605-a, a memory system may remap the capacity blocks 610. In particular, the memory system may remap the capacity blocks 610 that do not include errors (e.g., that are not associated with memory arrays storing data that includes errors that are not correctable by ECC circuitry at the memory system) to the second address space 605-b, while excluding the capacity blocks 610 (e.g., the capacity block 610-b) that include errors.

To remap the capacity blocks 610 to the second address space 605-b, the memory system may remap one or more of the portion of the capacity blocks 610 that are included in the second address space 605-b to ensure that the second address space 605-b provides a continuous memory range to a host system. In the example 600, the memory system may exclude the capacity block 610-b from the second address space 605-b, and update a mapping of the addresses within the capacity block 610-b to correspond to invalid addresses 620. In some cases, the memory system may update a capacity allocation lookup table (e.g., as illustrated by Table 1) to indicate that the capacity block identifier associated with the capacity block 610-b maps to the invalid addresses 620.

To remap the capacity blocks 610 that are included in the second address space 605-b, the memory system may update a capacity allocation lookup table (e.g., as illustrated by Table 1) as illustrated in example 600. For example, the memory system may replace, in the capacity allocation lookup table, the capacity block identifier of the capacity block 610-b with the capacity block identifier of the capacity block 610-c; the capacity block identifier of the capacity block 610-c with the capacity block identifier of the capacity block 610-d; the capacity block identifier of the capacity block 610-d with the capacity block identifier of the capacity block 610-e; and the capacity block identifier of the capacity block 610-e with the capacity block identifier of the capacity block 610-f.

In another example (e.g., not illustrated in the example 600), the memory system may instead replace the capacity block identifier 610-b with a last capacity block identifier (e.g., the capacity block identifier with the capacity block 610-f). Then, the memory system may update the last entry in the capacity allocation lookup table to indicate that the capacity block 610-b corresponds to the invalid addresses 620. In this example, the memory system may update fewer entries in the capacity allocation lookup table.

In either example, the memory system may also update a register at the memory device to indicate the range of the address space 605-b.

In the example 600, the memory system may not detect errors (e.g., uncorrectable errors) in memory arrays associated with any of the other capacity blocks 610 in the address space 605-a. Accordingly, the memory system may remap each of the capacity blocks 610 included in the address space 605-a

As indicated above, FIG. 6 is provided as an example. Other examples may differ from what is described with regard to FIG. 6.

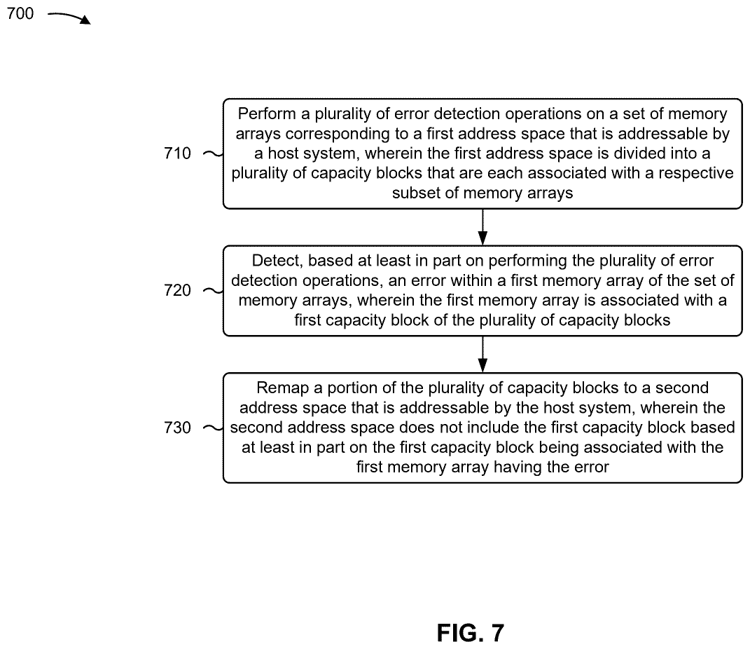

FIG. 7 is a flowchart of an example method 700 associated with a memory system with a dynamic capacity. In some implementations, a memory system (e.g., the memory system 110, the CXL compliant memory system 204) may perform or may be configured to perform the method 700. Additionally, or alternatively, one or more components of the memory system (e.g., the controller 315; the memory devices 320, 420, and 520) may perform or may be configured to perform the method 700. Thus, means for performing the method 700 may include the memory system and/or one or more components of the memory system. Additionally, or alternatively, a non-transitory computer-readable medium may store one or more instructions that, when executed by the memory system, cause the memory system to perform the method 700.

As shown in FIG. 7, the method 700 may include performing a plurality of error detection operations on a set of memory arrays corresponding to a first address space that is addressable by a host system, wherein the first address space is divided into a plurality of capacity blocks that are each associated with a respective subset of memory arrays (block 710). As further shown in FIG. 7, the method 700 may include detecting, based at least in part on performing the plurality of error detection operations, an error within a first memory array of the set of memory arrays, wherein the first memory array is associated with a first capacity block of the plurality of capacity blocks (block 720). As further shown in FIG. 7, the method 700 may include remapping a portion of the plurality of capacity blocks to a second address space that is addressable by the host system, wherein the second address space does not include the first capacity block based at least in part on the first capacity block being associated with the first memory array having the error (block 730).

The method 700 may include additional aspects, such as any single aspect or any combination of aspects described below and/or described in connection with one or more other methods or operations described elsewhere herein.

In a first aspect, the first capacity block comprises a first quantity of memory arrays from the set that is less than a second quantity of memory arrays from the set that are coupled to a single channel.

In a second aspect, alone or in combination with the first aspect, each respective subset of memory arrays comprises memory arrays coupled to each of a plurality of channels at the memory system, and the memory arrays in each respective subset of memory arrays are within a single memory bank.

In a third aspect, alone or in combination with one or more of the first and second aspects, each respective subset of memory arrays comprises memory arrays coupled to each of a plurality of channels at the memory system, and each respective subset of memory arrays comprises a memory array from each memory bank on a single layer.

In a fourth aspect, alone or in combination with one or more of the first through third aspects, the remapping comprises updating a bitmap at the memory system that indicates an association between the plurality of capacity blocks and each respective subset of memory arrays.

In a fifth aspect, alone or in combination with one or more of the first through fourth aspects, the method 700 includes indicating, to the host system, a size of the second address space based at least in part on the remapping.

In a sixth aspect, alone or in combination with one or more of the first through fifth aspects, indicating the size of the second address space comprises setting a register at the memory system to a value indicative of the size of the second address space.

In a seventh aspect, alone or in combination with one or more of the first through sixth aspects, the method 700 includes performing a scanning operation on the set of memory arrays, wherein performing the plurality of error detection operations occurs during the scanning operation.

In an eighth aspect, alone or in combination with one or more of the first through seventh aspects, the method 700 includes receiving a command from the host system indicating the scanning operation, wherein performing the scanning operation is based at least in part on receiving the command.

In a ninth aspect, alone or in combination with one or more of the first through eighth aspects, the method 700 includes performing an initialization procedure at the memory system, wherein performing the scanning operation is based at least in part on performing the initialization procedure.

In a tenth aspect, alone or in combination with one or more of the first through ninth aspects, performing the scanning operation comprises setting a register at the memory system to a first value indicative of the memory system performing the scanning operation, performing a set of read operations on the set of memory arrays, performing a set of write operations on the set of memory arrays, performing the plurality of error detection operations on the set of memory arrays based at least in part on performing the set of read operations and performing the set of write operations, and setting the register to a second value indicative of the memory system completing the scanning operation.

Although FIG. 7 shows example blocks of a method 700, in some implementations, the method 700 may include additional blocks, fewer blocks, different blocks, or differently arranged blocks than those depicted in FIG. 7. Additionally, or alternatively, two or more of the blocks of the method 700 may be performed in parallel. The method 700 is an example of one method that may be performed by one or more devices described herein. These one or more devices may perform or may be configured to perform one or more other methods based on operations described herein.

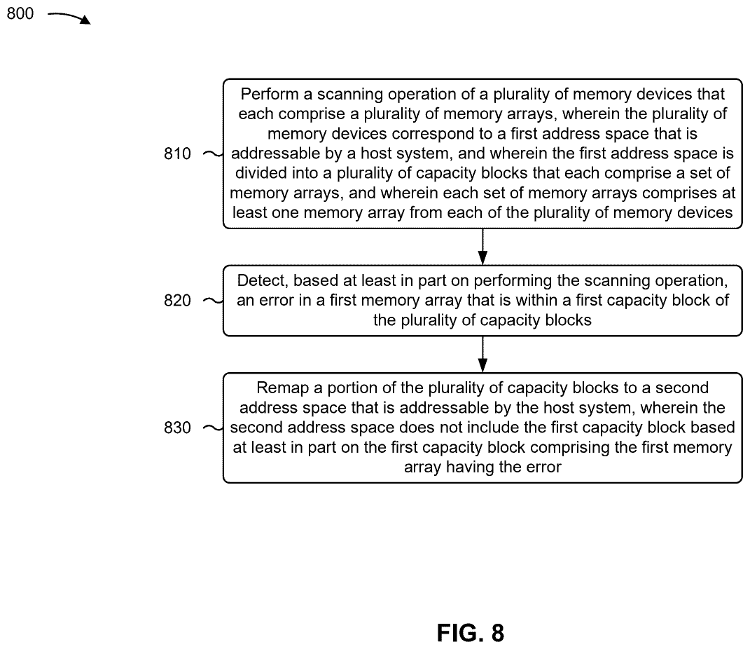

FIG. 8 is a flowchart of an example method 800 associated with a memory system with a dynamic capacity. In some implementations, a memory system (e.g., the memory system 110, the CXL compliant memory system 204) may perform or may be configured to perform the method 800. Additionally, or alternatively, one or more components of the memory system (e.g., the controller 315; the memory devices 320, 420, and 520) may perform or may be configured to perform the method 800. Thus, means for performing the method 800 may include the memory system and/or one or more components of the memory system. Additionally, or alternatively, a non-transitory computer-readable medium may store one or more instructions that, when executed by the memory system, cause the memory system to perform the method 800.

As shown in FIG. 8, the method 800 may include performing a scanning operation of a plurality of memory devices that each comprise a plurality of memory arrays, wherein the plurality of memory devices correspond to a first address space that is addressable by a host system, wherein the first address space is divided into a plurality of capacity blocks that each comprise a set of memory arrays, and wherein each set of memory arrays comprises at least one memory array from each of the plurality of memory devices (block 810). As further shown in FIG. 8, the method 800 may include detecting, based at least in part on performing the scanning operation, an error in a first memory array that is within a first capacity block of the plurality of capacity blocks (block 820). As further shown in FIG. 8, the method 800 may include remapping a portion of the plurality of capacity blocks to a second address space that is addressable by the host system, wherein the second address space does not include the first capacity block based at least in part on the first capacity block comprising the first memory array having the error (block 830).

The method 800 may include additional aspects, such as any single aspect or any combination of aspects described below and/or described in connection with one or more other methods or operations described elsewhere herein.

In a first aspect, the first capacity block comprises a first quantity of memory arrays that is less than a second quantity of memory arrays that are coupled to a single channel.

In a second aspect, alone or in combination with the first aspect, the memory arrays within each set of memory arrays are within a single memory bank.

In a third aspect, alone or in combination with one or more of the first and second aspects, each set of memory arrays comprises memory arrays from a plurality of memory banks.

Although FIG. 8 shows example blocks of a method 800, in some implementations, the method 800 may include additional blocks, fewer blocks, different blocks, or differently arranged blocks than those depicted in FIG. 8. Additionally, or alternatively, two or more of the blocks of the method 800 may be performed in parallel. The method 800 is an example of one method that may be performed by one or more devices described herein. These one or more devices may perform or may be configured to perform one or more other methods based on operations described herein.

In some implementations, a memory system includes a set of memory arrays comprising a plurality of disjoint subsets of memory arrays, wherein the set of memory arrays corresponds to a first address space that is addressable by a host system, and the first address space is divided into a plurality of capacity blocks that are each associated with a respective one of the plurality of disjoint subsets; error detection circuitry coupled to the set of memory arrays, the error detection circuitry configured to detect an error in a memory array within a first disjoint subset of the plurality of disjoint subsets; and a controller coupled to the set of memory arrays and the error detection circuitry, the controller configured to: remap a portion of the plurality of capacity blocks to a second address space that is addressable by the host system, wherein the second address space does not include a first capacity block based at least in part on the first capacity block being associated with the first disjoint subset comprising the error.

In some implementations, a method performed at a memory system includes performing a plurality of error detection operations on a set of memory arrays corresponding to a first address space that is addressable by a host system, wherein the first address space is divided into a plurality of capacity blocks that are each associated with a respective subset of memory arrays; detecting, based at least in part on performing the plurality of error detection operations, an error within a first memory array of the set of memory arrays, wherein the first memory array is associated with a first capacity block of the plurality of capacity blocks; and remapping a portion of the plurality of capacity blocks to a second address space that is addressable by the host system, wherein the second address space does not include the first capacity block based at least in part on the first capacity block being associated with the first memory array having the error.

In some implementations, an apparatus includes means for performing a scanning operation of a plurality of memory devices that each comprise a plurality of memory arrays, wherein the plurality of memory devices correspond to a first address space that is addressable by a host system, wherein the first address space is divided into a plurality of capacity blocks that each comprise a set of memory arrays, and wherein each set of memory arrays comprises at least one memory array from each of the plurality of memory devices; means for detecting, based at least in part on performing the scanning operation, an error in a first memory array that is within a first capacity block of the plurality of capacity blocks; and means for remapping a portion of the plurality of capacity blocks to a second address space that is addressable by the host system, wherein the second address space does not include the first capacity block based at least in part on the first capacity block comprising the first memory array having the error.

The foregoing disclosure provides illustration and description but is not intended to be exhaustive or to limit the implementations to the precise forms disclosed. Modifications and variations may be made in light of the above disclosure or may be acquired from practice of the implementations described herein.

Even though particular combinations of features are recited in the claims and/or disclosed in the specification, these combinations are not intended to limit the disclosure of implementations described herein. Many of these features may be combined in ways not specifically recited in the claims and/or disclosed in the specification. For example, the disclosure includes each dependent claim in a claim set in combination with every other individual claim in that claim set and every combination of multiple claims in that claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

When “a component” or “one or more components” (or another element, such as “a controller” or “one or more controllers”) is described or claimed (within a single claim or across multiple claims) as performing multiple operations or being configured to perform multiple operations, this language is intended to broadly cover a variety of architectures and environments. For example, unless explicitly claimed otherwise (e.g., via the use of “first component” and “second component” or other language that differentiates components in the claims), this language is intended to cover a single component performing or being configured to perform all of the operations, a group of components collectively performing or being configured to perform all of the operations, a first component performing or being configured to perform a first operation and a second component performing or being configured to perform a second operation, or any combination of components performing or being configured to perform the operations. For example, when a claim has the form “one or more components configured to: perform X; perform Y; and perform Z,” that claim should be interpreted to mean “one or more components configured to perform X; one or more (possibly different) components configured to perform Y; and one or more (also possibly different) components configured to perform Z.”

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Where only one item is intended, the phrase “only one,” “single,” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. As used herein, the term “multiple” can be replaced with “a plurality of” and vice versa. Also, as used herein, the term “or” is intended to be inclusive when used in a series and may be used interchangeably with “and/or,” unless explicitly stated otherwise (e.g., if used in combination with “either” or “only one of”).

What is claimed is:

1. A memory system, comprising:
a set of memory arrays comprising a plurality of disjoint subsets of memory arrays,
wherein the set of memory arrays corresponds to a first address space that is addressable by a host system, and
the first address space is divided into a plurality of capacity blocks that are each associated with a respective one of the plurality of disjoint subsets;
error detection circuitry coupled to the set of memory arrays, the error detection circuitry configured to detect an error in a memory array within a first disjoint subset of the plurality of disjoint subsets; and
a controller coupled to the set of memory arrays and the error detection circuitry, the controller configured to:
remap a portion of the plurality of capacity blocks to a second address space that is addressable by the host system, wherein the second address space does not include a first capacity block based at least in part on the first capacity block being associated with the first disjoint subset comprising the error.

2. The memory system of claim 1, further comprising:
a plurality of memory devices each comprising a first quantity of memory arrays from the set; and
a plurality of channels that each couple a respective one of the plurality of memory devices to the controller, wherein the first disjoint subset comprises a memory array from each of the plurality of memory devices.

3. The memory system of claim 2, wherein a second quantity of memory arrays within the first disjoint subset is less than the first quantity.

4. The memory system of claim 2, wherein the memory arrays within the first disjoint subset are within a single memory bank.

5. The memory system of claim 2, further comprising:
a plurality of memory banks that are associated with a single rank, wherein the first disjoint subset comprises memory arrays from each of the plurality of memory banks.

6. The memory system of claim 1, further comprising:
one or more memory cells coupled to the controller and configured to store a bitmap that indicates an association between each of the plurality of capacity blocks and a respective disjoint subset of memory arrays.

7. The memory system of claim 1, further comprising:
a register coupled to the controller and configured to indicate an address space size, wherein the controller is further configured to:
update the register from indicating a first address space size of the first address space to indicating a second address space size of the second address space based at least in part on remapping the portion of the plurality of capacity blocks.

8. The memory system of claim 1, wherein the controller is further configured to:
perform a scanning operation on the set of memory arrays, wherein the error detection circuitry detects the error in the memory array based at least in part on performing the scanning operation.

9. The memory system of claim 8, wherein the controller is further configured to:
perform an initialization procedure at the memory system, wherein performing the scanning operation occurs during the initialization procedure.

10. The memory system of claim 8, further comprising:
host interface circuitry coupled to the controller and configured to receive, from the host system, a command to perform the scanning operation, wherein performing the scanning operation is in response to receiving the command.

11. A method performed at a memory system, comprising:
performing a plurality of error detection operations on a set of memory arrays corresponding to a first address space that is addressable by a host system, wherein the first address space is divided into a plurality of capacity blocks that are each associated with a respective subset of memory arrays;
detecting, based at least in part on performing the plurality of error detection operations, an error within a first memory array of the set of memory arrays, wherein the first memory array is associated with a first capacity block of the plurality of capacity blocks; and
remapping a portion of the plurality of capacity blocks to a second address space that is addressable by the host system, wherein the second address space does not include the first capacity block based at least in part on the first capacity block being associated with the first memory array having the error.

12. The method of claim 11, wherein the first capacity block comprises a first quantity of memory arrays from the set that is less than a second quantity of memory arrays from the set that are coupled to a single channel.

13. The method of claim 11, wherein:
each respective subset of memory arrays comprises memory arrays coupled to each of a plurality of channels at the memory system, and
the memory arrays in each respective subset of memory arrays are within a single memory bank.

14. The method of claim 11, wherein:
each respective subset of memory arrays comprises memory arrays coupled to each of a plurality of channels at the memory system, and
each respective subset of memory arrays comprises a memory array from each memory bank on a single layer.

15. The method of claim 11, wherein the remapping comprises:
updating a bitmap at the memory system that indicates an association between the plurality of capacity blocks and each respective subset of memory arrays.

16. The method of claim 11, further comprising:
indicating, to the host system, a size of the second address space based at least in part on the remapping.

17. The method of claim 16, wherein indicating the size of the second address space comprises:
setting a register at the memory system to a value indicative of the size of the second address space.

18. The method of claim 11, further comprising:
performing a scanning operation on the set of memory arrays, wherein performing the plurality of error detection operations occurs during the scanning operation.

19. The method of claim 18, further comprising:
receiving a command from the host system indicating the scanning operation, wherein performing the scanning operation is based at least in part on receiving the command.

20. The method of claim 18, further comprising:
performing an initialization procedure at the memory system, wherein performing the scanning operation is based at least in part on performing the initialization procedure.

21. The method of claim 18, wherein performing the scanning operation comprises:
setting a register at the memory system to a first value indicative of the memory system performing the scanning operation;
performing a set of read operations on the set of memory arrays;
performing a set of write operations on the set of memory arrays;
performing the plurality of error detection operations on the set of memory arrays based at least in part on performing the set of read operations and performing the set of write operations; and
setting the register to a second value indicative of the memory system completing the scanning operation.

22. An apparatus, comprising:
means for performing a scanning operation of a plurality of memory devices that each comprise a plurality of memory arrays,
wherein the plurality of memory devices correspond to a first address space that is addressable by a host system,
wherein the first address space is divided into a plurality of capacity blocks that each comprise a set of memory arrays, and
wherein each set of memory arrays comprises at least one memory array from each of the plurality of memory devices;
means for detecting, based at least in part on performing the scanning operation, an error in a first memory array that is within a first capacity block of the plurality of capacity blocks; and
means for remapping a portion of the plurality of capacity blocks to a second address space that is addressable by the host system, wherein the second address space does not include the first capacity block based at least in part on the first capacity block comprising the first memory array having the error.

23. The apparatus of claim 22, wherein the first capacity block comprises a first quantity of memory arrays that is less than a second quantity of memory arrays that are coupled to a single channel.

24. The apparatus of claim 22, wherein the memory arrays within each set of memory arrays are within a single memory bank.

25. The apparatus of claim 22, wherein each set of memory arrays comprises memory arrays from a plurality of memory banks.
